(19) United States
(12) Patent Application Publication
(10) Pub. No.: US 2017/0108312 A1
(43) Pub. Date: Apr. 20, 2017

(54) ELECTROMAGNETIC CLOAKING AND TRANSLATION APPARATUS, METHODS, AND SYSTEMS

(71) Applicant: Searete LLC, Bellevue, WA (US)

(72) Inventor: JORDIN T. KARE, SAN JOSE, CA (US)

(21) Appl. No.: 15/338,749

(22) Filed: Oct. 31, 2016

Related U.S. Application Data
(63) Continuation of application No. 12/074,247, filed on Feb. 29, 2008, now abandoned.

(51) Int. Cl. F41H 3/00; H01Q 5/30; G02B 1/00

(52) U.S. Cl. CPC F41H 3/00; G02B 1/002; G02B 1/007; H01Q 5/30

(57) ABSTRACT

Apparatus, methods, and systems provide electromagnetic cloaking and/or translation. In some approaches the electromagnetic cloaking and/or translation is achieved with transformation media. In some approaches the electromagnetic cloaking and/or translation is achieved with metamaterials.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

The present application constitutes a continuation-in-part of U.S. patent application Ser. No. 12/074,247, entitled ELECTROMAGNETIC CLOAKING AND TRANSLATION APPARATUS, METHODS, AND SYSTEMS, naming JORDIN T. KARE as inventor, filed 29 Feb. 2008 with attorney docket no. 0206-011-002-000000, which is currently co-pending or is an application of which a currently co-pending application is entitled to the benefit of the filing date.

### RELATED APPLICATIONS

None.

If the listings of applications provided above are inconsistent with the listings provided via an ADS, it is the intent of the Applicant to claim priority to each application that appears in the Priority Applications section of the ADS and to each application that appears in the Priority Applications section of this application. All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### TECHNICAL FIELD

The application discloses apparatus, methods, and systems that may relate to electromagnetic responses that include electromagnetic cloaking and/or electromagnetic translation.

### BRIEF DESCRIPTION OF THE FIGURES

FIGS. 1-9 depict electromagnetic transducers with electromagnetic cloaking and/or translation structures.

FIGS. 10-11 depict a focusing structure with electromagnetic transducers and an electromagnetic cloaking and/or translation structure.

FIGS. 12-13 depict a steerable electromagnetic transducer with an obstruction and an electromagnetic cloaking structure.

FIGS. 14-15 depict aperture antennas with an aperture-blocking element and an electromagnetic cloaking structure.

FIGS. 16-18 depict one or more electromagnetic transducers with an obstruction, an electromagnetic cloaking structure, and a controller.

FIG. 19 depicts an electromagnetic cloaking and/or translation system.

FIGS. 20-23 depict process flows.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Transformation optics is an emerging field of electromagnetic engineering. Transformation optics devices include lenses that refract electromagnetic waves, where the refraction imitates the bending of light in a curved coordinate space (a “transformation” of a flat coordinate space), e.g. as described in A. J. Ward and J. B. Pendry, “Refraction and geometry in Maxwell's equations,” J. Mod. Optics 43, 773 (1996), J. B. Pendry and S. A. Ramakrishna, “Focusing light using negative refraction,” J. Phys. [Cond. Matt.] 15, 6345 (2003), D. Schurig et al, “Calculation of material properties and ray tracing in transformation media,” Optics Express 14, 9794 (2006) (“D. Schurig et al (1)”), and in U. Leonhardt and T. G. Philbin, “General relativity in electrical engineering,” New J. Phys. 8, 247 (2006), each of which is herein incorporated by reference. The use of the term “optics” does not imply any limitation with regards to wavelength; a transformation optics device may be operable in wavelength bands that range from radio wavelengths to visible wavelengths.

A first exemplary transformation optics device is the electromagnetic cloak that was described, simulated, and implemented, respectively, in J. B. Pendry et al, “Controlling electromagnetic waves,” Science 312, 1780 (2006); S. A. Cummer et al, “Full-wave simulations of electromagnetic cloaking structures,” Phys. Rev. E 74, 036621 (2006); and D. Schurig et al, “Metamaterial electromagnetic cloak at microwave frequencies,” Science 314, 977 (2006) (“D. Schurig et al (2)”); each of which is herein incorporated by reference. See also J. Pendry et al, “Electromagnetic cloaking method,” U.S. patent application Ser. No. 11/459,728, herein incorporated by reference. For the electromagnetic cloak, the curved coordinate space is a transformation of a flat space that has been punctured and stretched to create a hole (the cloaked region), and this transformation corresponds to a set of constitutive parameters (electric permittivity and magnetic permeability) for a transformation medium wherein electromagnetic waves are refracted around the hole in imitation of the curved coordinate space.

A second exemplary transformation optics device is illustrated by embodiments of the electromagnetic compression structure described in J. B. Pendry, D. Schurig, and D. R. Smith, “Electromagnetic compression apparatus, methods, and systems,” U.S. patent application Ser. No. 11/982,353; and in J. B. Pendry, D. Schurig, and D. R. Smith, “Electromagnetic compression apparatus, methods, and systems,” U.S. patent application Ser. No. 12/069,170; each of which is herein incorporated by reference. In embodiments described therein, an electromagnetic compression structure includes a transformation medium with constitutive parameters corresponding to a coordinate transformation that compresses a region of space intermediate first and second spatial locations, the effective spatial compression being applied along an axis joining the first and second spatial locations. The electromagnetic compression structure thereby provides an effective electromagnetic distance between the first and second spatial locations greater than a physical distance between the first and second spatial locations.

In general, for a selected coordinate transformation, a transformation medium can be identified wherein electromagnetic waves refract as if propagating in a curved coordinate space corresponding to the selected coordinate transformation. Constitutive parameters of the transformation medium can be obtained from the equations:

\tilde{∈}^{i′j′}=|det(Λᵢ^{i′})|⁻¹Λᵢ^{i′Λ}ⱼ^{j′}∈^{ij} (4)

\tilde{μ}^{i′j′}=|det(Λᵢ^{i′})|⁻¹Λᵢ^{i′}Λⱼ^{j′}μ^{ij} (5)

where \tilde{∈} and \tilde{μ} are the permittivity and permeability tensors of the transformation medium, ∈ and μ are the permittivity and permeability tensors of the original medium in the untransformed coordinate space, and

$${Λ}_{i}^{{i}^{′}} = \frac{\partial {x}^{{i}^{′}}}{\partial {x}^{i}} \qquad ( 6 )$$

is the Jacobian matrix corresponding to the coordinate transformation. In some applications, the coordinate transformation is a one-to-one mapping of locations in the untransformed coordinate space to locations in the transformed coordinate space, and in other applications the coordinate transformation is a many-to-one mapping of locations in the untransformed coordinate space to locations in the transformed coordinate space. Some coordinate transformations, such as many-to-one mappings, may correspond to a transformation medium having a negative index of refraction. In some applications, only selected matrix elements of the permittivity and permeability tensors need satisfy equations (1) and (2), e.g. where the transformation optics response is for a selected polarization only. In other applications, a first set of permittivity and permeability matrix elements satisfy equations (1) and (2) with a first Jacobian Λ, corresponding to a first transformation optics response for a first polarization of electromagnetic waves, and a second set of permittivity and permeability matrix elements, orthogonal (or otherwise complementary) to the first set of matrix elements, satisfy equations (1) and (2) with a second Jacobian Λ′, corresponding to a second transformation optics response for a second polarization of electromagnetic waves. In yet other applications, reduced parameters are used that may not satisfy equations (1) and (2), but preserve products of selected elements in (1) and selected elements in (2), thus preserving dispersion relations inside the transformation medium (see, for example, D. Schurig et al (2), supra, and W. Cai et al, “Optical cloaking with metamaterials,” Nature Photonics 1, 224 (2007), herein incorporated by reference). Reduced parameters can be used, for example, to substitute a magnetic response for an electric response, or vice versa. While reduced parameters preserve dispersion relations inside the transformation medium (so that the ray or wave trajectories inside the transformation medium are unchanged from those of equations (1) and (2)), they may not preserve impedance characteristics of the transformation medium, so that rays or waves incident upon a boundary or interface of the transformation medium may sustain reflections (whereas in general a transformation medium according to equations (1) and (2) is substantially nonreflective). The reflective or scattering characteristics of a transformation medium with reduced parameters can be substantially reduced or eliminated by a suitable choice of coordinate transformation, e.g. by selecting a coordinate transformation for which the corresponding Jacobian Λ (or a subset of elements thereof) is continuous or substantially continuous at a boundary or interface of the transformation medium (see, for example, W. Cai et al, “Nonmagnetic cloak with minimized scattering,” Appl. Phys. Lett. 91, 111105 (2007), herein incorporated by reference).

In general, constitutive parameters (such as permittivity and permeability) of a medium responsive to an electromagnetic wave can vary with respect to a frequency of the electromagnetic wave (or equivalently, with respect to a wavelength of the electromagnetic wave in vacuum or in a reference medium). Thus, a medium can have constitutive parameters ∈₁, μ₁, etc. at a first frequency, and constitutive parameters ∈₂, μ₂, etc. at a second frequency; and so on for a plurality of constitutive parameters at a plurality of frequencies. In the context of a transformation medium, constitutive parameters at a first frequency can provide a first response to electromagnetic waves at the first frequency, corresponding to a first selected coordinate transformation, and constitutive parameters at a second frequency can provide a second response to electromagnetic waves at the second frequency, corresponding to a second selected coordinate transformation; and so on: a plurality of constitutive parameters at a plurality of frequencies can provide a plurality of responses to electromagnetic waves corresponding to a plurality of coordinate transformations. In some embodiments the first response at the first frequency is substantially nonzero (i.e. one or both of ∈₁ and μ₁ is substantially non-unity), corresponding to a nontrivial coordinate transformation, and a second response at a second frequency is substantially zero (i.e. ∈₂ and μ₂ are substantially unity), corresponding to a trivial coordinate transformation (i.e. a coordinate transformation that leaves the coordinates unchanged); thus, electromagnetic waves at the first frequency are refracted (substantially according to the nontrivial coordinate transformation), and electromagnetic waves at the second frequency are substantially nonrefracted. Constitutive parameters of a medium can also change with time (e.g. in response to an external input or control signal), so that the response to an electromagnetic wave can vary with respect to frequency and/or time. Some embodiments exploit this variation with frequency and/or time to provide respective frequency and/or time multiplexing/demultiplexing of electromagnetic waves. Thus, for example, a transformation medium can have a first response at a frequency at time t₁, corresponding to a first selected coordinate transformation, and a second response at the same frequency at time t₂, corresponding to a second selected coordinate transformation. As another example, a transformation medium can have a response at a first frequency at time t₁, corresponding to a selected coordinate transformation, and substantially the same response at a second frequency at time t₂. In yet another example, a transformation medium can have, at time t₁, a first response at a first frequency and a second response at a second frequency, whereas at time t₂, the responses are switched, i.e. the second response (or a substantial equivalent thereof) is at the first frequency and the first response (or a substantial equivalent thereof) is at the second frequency. The second response can be a zero or substantially zero response. Other embodiments that utilize frequency and/or time dependence of the transformation medium will be apparent to one of skill in the art.

Constitutive parameters such as those of equations (1) and (2) (or reduced parameters derived therefrom) can be realized using metamaterials. Generally speaking, electromagnetic properties of metamaterials derive from the metamaterial structures, rather than or in addition to their material composition. Some exemplary metamaterials are described in R. A. Hyde et al, “Variable metamaterial apparatus,” U.S. patent application Ser. No. 11/355,493; D. Smith et al, “Metamaterials,” International Application No. PCT/US2005/026052; D. Smith et al, “Metamaterials and negative refractive index,” Science 305, 788 (2004); and D. Smith et al, “Indefinite materials,” U.S. patent application Ser. No. 10/525,191; each herein incorporated by reference. Metamaterials generally feature subwavelength elements, i.e. structural elements having a length scale smaller than an operating wavelength of the metamaterial, and the subwavelength elements have a collective response to electromagnetic radiation that corresponds to an effective continuous medium response, characterized by an effective permittivity, an effective permeability, an effective magnetoelectric coefficient, or any combination thereof. For example, the electromagnetic radiation may induce charges and/or currents in the subwavelength elements, whereby the subwavelength elements acquire nonzero electric and/or magnetic dipole moments. Where the electric component of the electromagnetic radiation induces electric dipole moments, the metamaterial has an effective permittivity; where the magnetic component of the electromagnetic radiation induces magnetic dipole moments, the metamaterial has an effective permeability; and where the electric (magnetic) component induces magnetic (electric) dipole moments (as in a chiral metamaterial), the metamaterial has an effective magnetoelectric coefficient. Some metamaterials provide an artificial magnetic response; for example, split-ring resonators built from nonmagnetic conductors can exhibit an effective magnetic permeability (c.f. J. B. Pendry et al, “Magnetism from conductors and enhanced nonlinear phenomena,” IEEE Trans. Micro. Theo. Tech. 47, 2075 (1999), herein incorporated by reference). Some metamaterials have “hybrid” electromagnetic properties that emerge partially from structural characteristics of the metamaterial, and partially from intrinsic properties of the constituent materials. For example, G. Dewar, “A thin wire array and magnetic host structure with n<0,” J. Appl. Phys. 97, 10Q101 (2005), herein incorporated by reference, describes a metamaterial consisting of a wire array (exhibiting a negative permeability as a consequence of its structure) embedded in a nonconducting ferrimagnetic host medium (exhibiting an intrinsic negative permeability). Metamaterials can be designed and fabricated to exhibit selected permittivities, permeabilities, and/or magnetoelectric coefficients that depend upon material properties of the constituent materials as well as shapes, chiralities, configurations, positions, orientations, and couplings between the subwavelength elements. The selected permittivites, permeabilities, and/or magnetoelectric coefficients can be positive or negative, complex (having loss or gain), anisotropic, variable in space (as in a gradient index lens), variable in time (e.g. in response to an external or feedback signal), variable in frequency (e.g. in the vicinity of a resonant frequency of the metamaterial), or any combination thereof. The selected electromagnetic properties can be provided at wavelengths that range from radio wavelengths to infrared/visible wavelengths (c.f. S. Linden et al, “Photonic metamaterials: Magnetism at optical frequencies,” IEEE J. Select. Top. Quant. Elect. 12, 1097 (2006) and V. Shalaev, “Optical negative-index metamaterials,” Nature Photonics 1, 41 (2007), both herein incorporated by reference). While many exemplary metamaterials are described as including discrete elements, some implementations of metamaterials may include non-discrete elements; for example, a metamaterial may include elements comprised of sub-elements, where the sub-elements are discrete structures (such as split-ring resonators, etc.), or the metamaterial may include elements that are inclusions, exclusions, layers, or other variations along some continuous structure (e.g. etchings on a substrate).

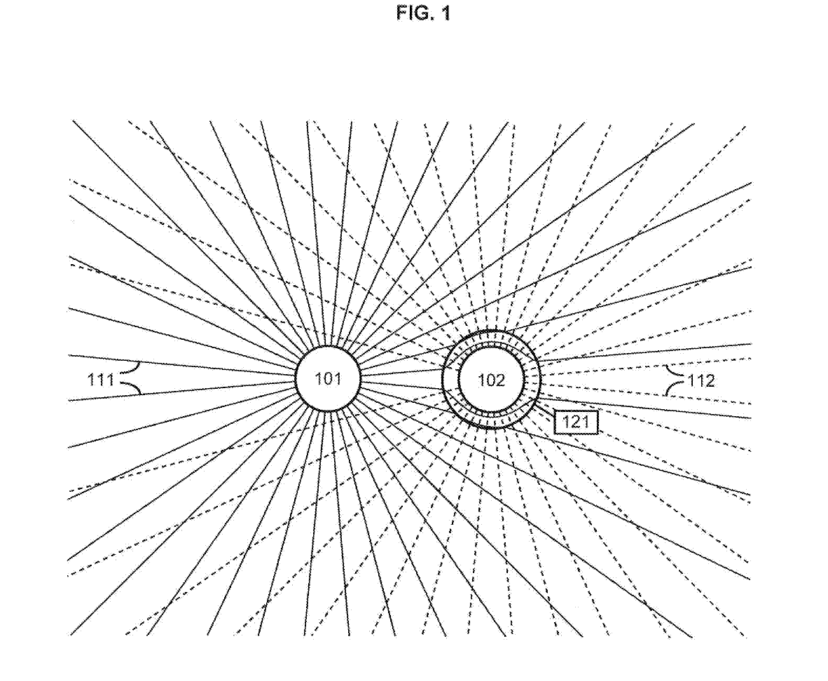

With reference now to FIG. 1, an illustrative embodiment is depicted that includes first and second electromagnetic transducers 101 and 102 operable at first and second frequencies, respectively. This and other drawings, unless context dictates otherwise, can represent a planar view of a three-dimensional embodiment, or a two-dimensional embodiment (e.g. in FIG. 1 where the transducers are positioned inside a metallic or dielectric slab waveguide oriented normal to the page). The solid rays 111 represent electromagnetic radiation at the first frequency, propagating in a first field of regard of the first electromagnetic transducer. The second electromagnetic transducer 102, positioned within the first field of regard, is enclosed by a first electromagnetic cloaking structure 121 operable to divert the rays 111 around the second electromagnetic transducer. The use of ray description is a heuristic convenience for purposes of visual illustration, and is not intended to connote any limitations or assumptions of geometrical optics. Further; the elements depicted in FIG. 1 can have spatial dimensions that are variously less than, greater than, or comparable to a wavelength of interest. With rays 111 radiating in every direction, FIG. 1 indicates a first field of regard that encompasses the entire space surrounding the first electromagnetic transducer (i.e. an omnidirectional field of regard), but other embodiments can have a narrower first field of regard. Moreover, the second electromagnetic transducer may be positioned only partially within the first field of regard. The first electromagnetic cloaking structure 121 is depicted as a shell or annulus that surrounds the second electromagnetic transducer, but this is a schematic depiction; in various embodiments the first electromagnetic cloaking structure can take various shapes, need not adjoin the second electromagnetic transducer, may only partially divert electromagnetic radiation at the first frequency around the second electromagnetic transducer, and/or may only partially surround the second electromagnetic transducer. The dashed rays 112 represent electromagnetic radiation at the second frequency, propagating in a second field of regard of the second electromagnetic transducer (other embodiments can have a narrower second field of regard than that depicted in FIG. 1). Rays that would be obstructed by, or otherwise interact with, the first electromagnetic transducer are not depicted, reflecting the absence of a second electromagnetic cloaking structure in this embodiment. As illustrated in the figure, the electromagnetic radiation at the second frequency (112) may propagate through the first electromagnetic cloaking structure 121 without substantial refraction or reflection. In other embodiments, e.g. where the first electromagnetic cloaking structure does not entirely surround the second electromagnetic transducer, the first electromagnetic cloaking structure may be partially or completely outside the second field of regard.

In general, electromagnetic transducers, such as those depicted in FIG. 1 and other embodiments, are electromagnetic devices that convert some energy or signal into electromagnetic radiation, or that convert electromagnetic radiation into some energy or signal, or both. Electromagnetic transducers can include antennas (such as wire/loop antennas, horn antennas, reflector antennas, patch antennas, phased arrays antennas, etc.) or any other devices operable to emit (transmit) and/or detect (receive or absorb) electromagnetic radiation, including but not limited to lasers/masers, cavity resonators such as magnetrons or klystrons, incandescent lamps, photoluminescent devices such as fluorescent lamps, cathodoluminescent devices such as cathode ray tubes, electroluminescent devices such as light-emitting diodes or semiconductor lasers, photodetectors/photosensors (such as photodiodes, photomultiplier tubes, thermal/cryogenic detectors, and CCDs), etc. Electromagnetic transducers can include focusing or imaging structures or assemblies, as in an optical imaging system (e.g. a telescope). Electromagnetic transducers can be operable to transmit only, to receive only, or to both transmit and receive, as with an active sensor that transmits electromagnetic radiation and then receives a radiation response (e.g. a radar or LIDAR device). Electromagnetic transducers can be operable at frequencies or frequency bands that include radio frequencies, microwave frequencies, millimeter- or submillimeter-wave frequencies, THz-wave frequencies, optical frequencies (e.g. variously corresponding to soft x-rays, extreme ultraviolet, ultraviolet, visible, near-infrared, infrared, or far infrared light), etc. For embodiments that recite first and second frequencies, the first and second frequencies may be selected from these frequency categories. Moreover, for these embodiments, the recitation of first and second frequencies may generally be replaced by a recitation of first and second frequency bands, again selected from the above frequency categories. Electromagnetic transducers can be operable in frequency bands having various bandwidths; some embodiments, for example, include a narrow-band emitter and a wide-band receiver (e.g. as the first and second electromagnetic transducers, respectively). An electromagnetic transducer can define a field of regard as a region wherein electromagnetic radiation may be coupled to the electromagnetic transducer (e.g. a region wherein electromagnetic radiation emitted or received by the electromagnetic transducer can propagate). An electromagnetic transducer that is steerable may also define a field of view within the field of regard, where the field of view is adjusted or scanned by steering the electromagnetic transducer. Examples of steerable electromagnetic transducers include mechanically steerable electromagnetic transducers (e.g. an antenna mounted on one or more gimbals) and electrically steerable electromagnetic transducers (e.g. an adjustably phased array).

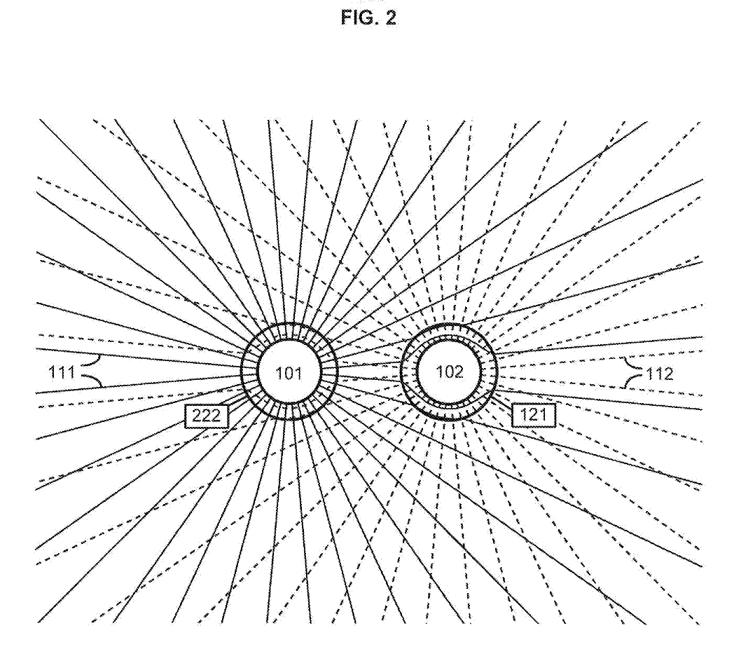

With reference now to FIG. 2, an illustrative embodiment is depicted that, as in FIG. 1, includes first and second electromagnetic transducers 101 and 102, rays 111 and 112 representing electromagnetic radiation at first and second frequencies (propagating in respective first and second fields of regard of the first and second electromagnetic transducers), and a first electromagnetic cloaking structure 121, operable to at least partially divert electromagnetic radiation at the first frequency around the second electromagnetic transducer. As in FIG. 1, the first and second fields of regard are depicted as omnidirectional, but other embodiments have narrower field(s) of regard. The embodiment of FIG. 2 further includes a second electromagnetic cloaking structure 222, operable to divert rays 112 around the first electromagnetic transducer (the first electromagnetic transducer being positioned with the second field of regard). In other embodiments, the second field of regard is narrower, and/or the first electromagnetic transducer is positioned only partially within the second field of regard. The second electromagnetic cloaking structure 222 is depicted as a shell or annulus that surrounds the first electromagnetic transducer, but this is a schematic depiction; in various embodiments the second electromagnetic cloaking structure can take various shapes, need not adjoin the first electromagnetic transducer, may only partially divert electromagnetic radiation at the second frequency around the first electromagnetic transducer, and/or may only partially surround the first electromagnetic transducer. As illustrated in the figure, the electromagnetic radiation at the first frequency (111) may propagate through the second electromagnetic cloaking structure 222 without substantial refraction or reflection. In other embodiments, e.g. where the second electromagnetic cloaking structure does not entirely surround the first electromagnetic transducer, the first electromagnetic cloaking structure may be partially or completely outside the first field of regard.

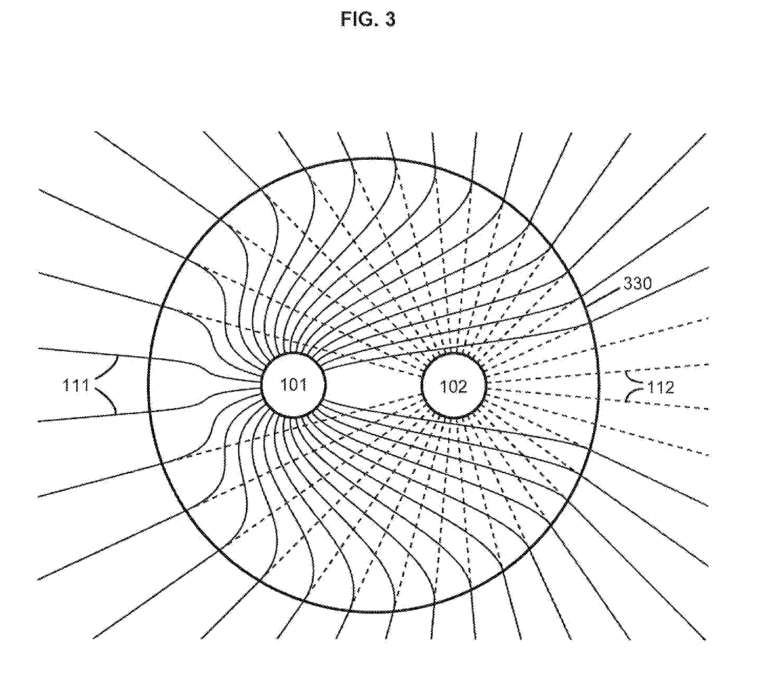

With reference now to FIG. 3, an illustrative embodiment is depicted that, as in FIGS. 1-2, includes first and second electromagnetic transducers 101 and 102, and rays 111 and 112 representing electromagnetic radiation at first and second frequencies (propagating in respective first and second fields of regard of the first and second electromagnetic transducers). As before, the first and second fields of regard are depicted as omnidirectional, but other embodiments have narrower field(s) of regard. The embodiment of FIG. 3 provides an electromagnetic translation structure 330 that encloses the first and second electromagnetic transducers. The rays 111 are refracted as they propagate through the electromagnetic translation structure, to provide an apparent location of the first electromagnetic transducer different than an actual location of the first electromagnetic transducer with regard to electromagnetic radiation at the first frequency (in the figure, the apparent location is equal to an actual location of the second electromagnetic transducer, but other embodiments provide other apparent locations). As elsewhere in this document, the use of ray description is a heuristic convenience for purposes of visual illustration, and is not intended to connote any limitations or assumptions of geometrical optics; the depicted elements can have spatial dimensions that are variously less than, greater than, or comparable to a wavelength of interest. The electromagnetic translation structure is depicted as a disk or sphere with two interior cavities to accommodate the two electromagnetic transducers, but this is a schematic depiction only; in various embodiments the electromagnetic translation structure can take various shapes, may be operable only within a narrower first field of regard, need not adjoin either electromagnetic transducer, and/or may not surround or may only partially surround either electromagnetic transducer. As illustrated in the figure, the electromagnetic radiation at the second frequency (112) may propagate through the electromagnetic translation structure 330 without substantial refraction or reflection. In other embodiments, the electromagnetic translation structure may be partially or completely outside the second field of regard. Rays 111 that would be obstructed by, or otherwise interact with, the second electromagnetic transducer are omitted in the figure; as are rays 112 that would be obstructed by, or otherwise interact with, the first electromagnetic transducer; these omissions reflect the absence of electromagnetic cloaking structures in this embodiment.

In some embodiments an electromagnetic translation structure, such as that depicted in FIG. 3, includes a transformation medium. For example, the ray trajectories 111 in FIG. 3 correspond to a coordinate transformation (i.e. one that maps or translates coordinates of an apparent location, such as the location of the second electromagnetic transducer, to coordinates of an actual location of the first electromagnetic transducer); this coordinate transformation can be used to identify constitutive parameters for a corresponding transformation medium (e.g. as provided in equations (1) and (2), or reduced parameters obtained therefrom) that responds to electromagnetic radiation as in FIG. 3. In some embodiments the transformation medium has a negative index of refraction, e.g. where the coordinate transformation that translates the apparent location to the actual location is a many-to-one mapping. In general, embodiments of an electromagnetic translation structure, operable to provide an apparent location of an electromagnetic transducer different than an actual location of the electromagnetic transducer, may comprise a transformation medium, the transformation medium corresponding to a coordinate transformation that maps or translates the apparent location to the actual location; and the constitutive relations of this transformation medium may be implemented with metamaterials, as described previously.

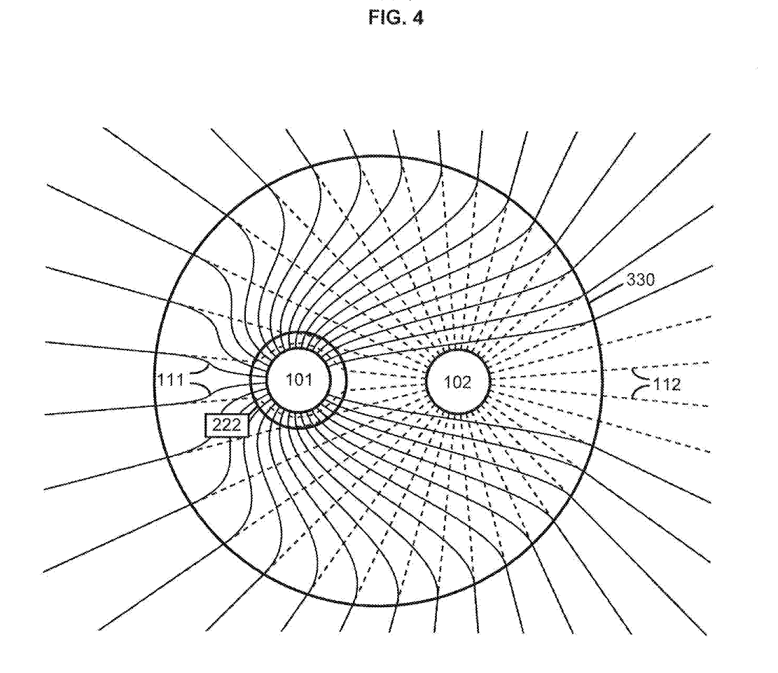

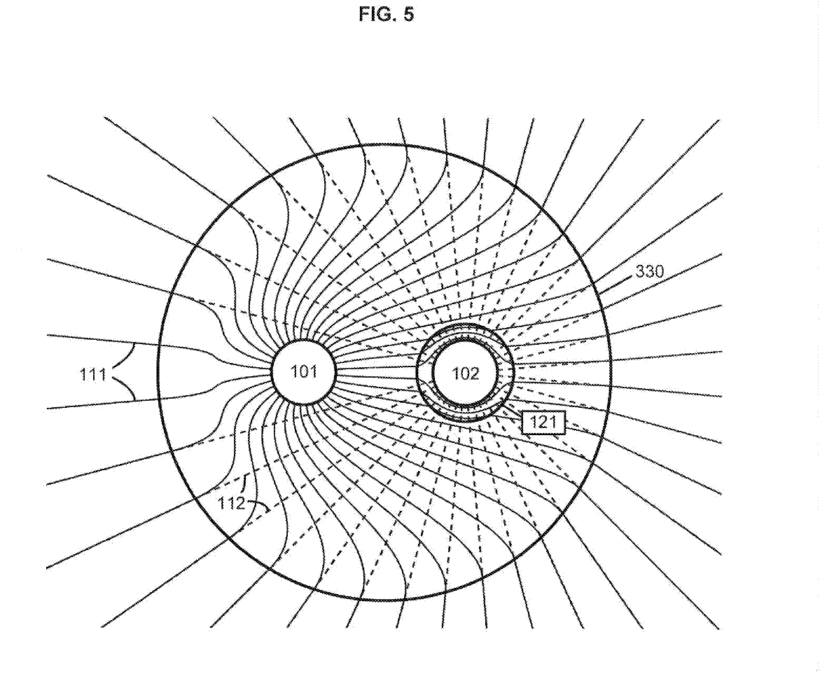

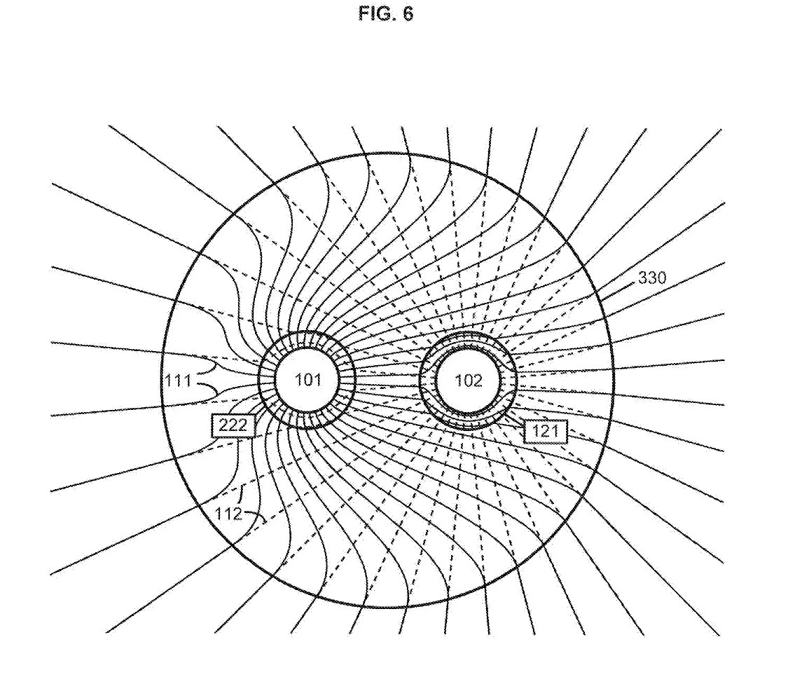

With reference now to FIGS. 4-6, illustrative embodiments are depicted that, as in FIG. 3, include first and second electromagnetic transducers 101 and 102, rays 111 and 112 representing electromagnetic radiation at first and second frequencies (propagating in respective first and second fields of regard of the first and second electromagnetic transducers), and an electromagnetic translation structure 330 operable to provide an apparent location of the first electromagnetic transducer different than an actual location of the first electromagnetic transducer with regard to electromagnetic radiation at the first frequency. The illustrative embodiments in FIGS. 4-6 further include one or both of the following: a first electromagnetic cloaking structure 121, operable to at least partially divert electromagnetic radiation at the first frequency around the second electromagnetic transducer, and a second electromagnetic cloaking structure 222, operable to at least partially divert electromagnetic radiation at the second frequency around the first electromagnetic transducer. In these figures, the depictions of the electromagnetic translation structure and the electromagnetic cloaking structures are schematic depictions only. Embodiments provide other shapes or extents of these structures, and other assemblies or configurations thereof. In some embodiments the structures are spatially separated from the other structures and/or from the electromagnetic transducers. In other embodiments the structures 121, 222, and/or 330 can be merged into, or replaced by, structures that combine operabilities of the original structures; with reference to FIG. 5, for example, an alternative embodiment merges the first electromagnetic cloaking structure 121 and the electromagnetic translation structure 330 into an electromagnetic cloaking-and-translation structure operable to provide an apparent location of the first electromagnetic transducer different than an actual location of the first electromagnetic transducer for electromagnetic radiation at the first frequency, and further operable to divert electromagnetic radiation at the first frequency around the second electromagnetic transducer. In some embodiments, the structures 121, 222, and/or 330 can superimpose or overlap (e.g. by interleaving elements that comprise the structures); with reference to FIG. 4, for example, an alternative embodiment overlaps the electromagnetic translation structure 330 with the second electromagnetic cloaking structure 222 by interleaving a first set of elements, responsive at a first frequency and comprising at least a portion of the electromagnetic translation structure, with a second set of elements, responsive at a second frequency and comprising at least a portion of the second electromagnetic cloaking structure.

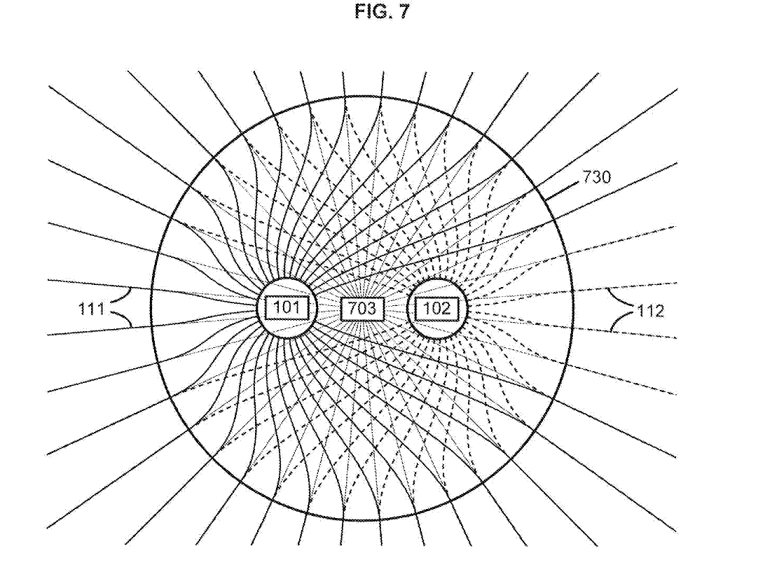

With reference now to FIG. 7, an illustrative embodiment is depicted that includes first and second electromagnetic transducers 101 and 102, and rays 111 and 112 representing electromagnetic radiation at first and second frequencies (propagating in respective first and second fields of regard of the first and second electromagnetic transducers). As before, the first and second fields of regard are depicted as omnidirectional, but other embodiments have narrower field(s) of regard. The embodiment of FIG. 7 provides an electromagnetic translation structure operable at first and second frequencies, 730, that encloses the first and second electromagnetic transducers. The rays 111 are refracted as they propagate through the electromagnetic translation structure operable at first and second frequencies, to provide a first apparent location (703) of the first electromagnetic transducer different than a first actual location of the first electromagnetic transducer with regard to electromagnetic radiation at the first frequency. The rays 112 are also refracted as they propagate through the electromagnetic translation structure operable at first and second frequencies, to provide a second apparent location (703) of the second electromagnetic transducer different than a second actual location of the second electromagnetic transducer (in the figure, the first apparent location coincides with the second apparent location, but other embodiments provide spatially separated first and second apparent locations). The faint lines that radiate from 703 are guidelines to illustrate that the rays 111 and 112 appear to radiate from location 703. As elsewhere in this document, the use of ray description is a heuristic convenience for purposes of visual illustration, and is not intended to connote any limitations or assumptions of geometrical optics; the depicted elements can have spatial dimensions that are variously less than, greater than, or comparable to a wavelength of interest. The electromagnetic translation structure operable at first and second frequencies is depicted as a disk or sphere with two interior cavities to accommodate the two electromagnetic transducers, but this is a schematic depiction only; in various embodiments the electromagnetic translation structure operable at first and second frequencies can take various shapes, may be operable only within narrower field(s) of regard, need not adjoin either electromagnetic transducer, and/or may not surround or may only partially surround either electromagnetic transducer. Rays 111 that would be obstructed by, or otherwise interact with, the second electromagnetic transducer are omitted in the figure; as are rays 112 that would be obstructed by, or otherwise interact with, the first electromagnetic transducer; these omissions reflect the absence of electromagnetic cloaking structures in this embodiment.

In some embodiments an electromagnetic translation structure operable at first and second frequencies, such as that depicted in FIG. 7, includes a transformation medium having an adjustable response to electromagnetic radiation. For example, the transformation medium may have a response to electromagnetic radiation that is adjustable (e.g. in response to an external input or control signal) between a first response and a second response, the first response providing a first apparent location of a first electromagnetic transducer different than a first actual location of the first electromagnetic transducer for electromagnetic radiation at a first frequency, and the second response providing a second apparent location of a second electromagnetic transducer different than a second actual location of the second electromagnetic transducer for electromagnetic radiation at a second frequency. A transformation medium with an adjustable electromagnetic response may be implemented with variable metamaterials, e.g. as described in R. A. Hyde et al, supra. In other embodiments an electromagnetic translation structure operable at first and second frequencies, such as that depicted in FIG. 7, includes a transformation medium having a frequency-dependent response to electromagnetic radiation, corresponding to frequency-dependent constitutive parameters. For example, the frequency-dependent response at a first frequency may provide a first apparent location of a first electromagnetic transducer different than a first actual location of the first electromagnetic transducer for electromagnetic radiation at a first frequency, and the frequency-dependent response at a second frequency may provide a second apparent location of a second electromagnetic transducer different than a second actual location of the second electromagnetic transducer for electromagnetic radiation at a second frequency. A transformation medium having a frequency-dependent response to electromagnetic radiation can be implemented with metamaterials; for example, a first set of metamaterial elements having a response at the first frequency may be interleaved with a second set of metamaterial elements having a response at the second frequency. Alternatively or equivalently, in some embodiments the electromagnetic translation structure operable at first and second frequencies is a combination of a first electromagnetic translation structure operable at the first frequency and a second electromagnetic translation structure operable at the second frequency; where the structures are combined by, for example, interleaving of their respective elements.

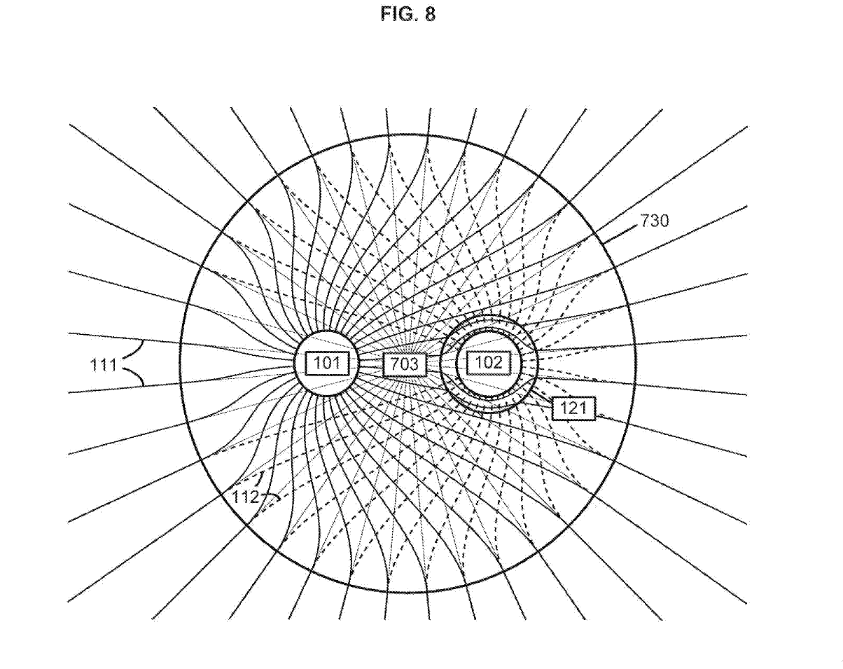

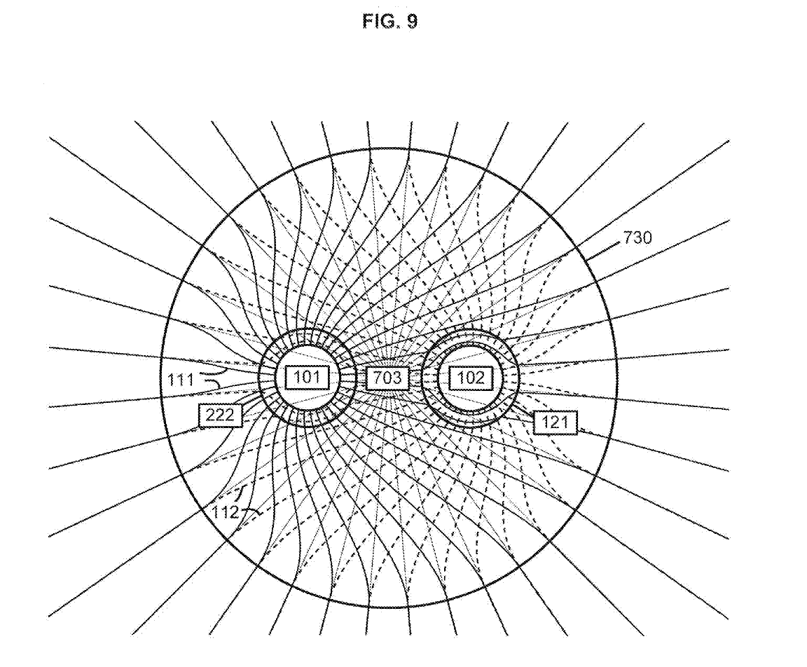

With reference now to FIGS. 8-9, illustrative embodiments are depicted that, as in FIG. 7, include first and second electromagnetic transducers 101 and 102, rays 111 and 112 representing electromagnetic radiation at first and second frequencies (propagating in respective first and second fields of regard of the first and second electromagnetic transducers), and an electromagnetic translation structure operable at first and second frequencies, 730. The electromagnetic translation structure operable at first and second frequencies is operable to provide a first apparent location (703) of the first electromagnetic transducer different than an actual location of the first electromagnetic transducer for electromagnetic radiation at the first frequency, and to provide a second apparent location (703) of the second electromagnetic transducer different than an actual location of the second electromagnetic transducer for electromagnetic radiation at the second frequency (as in FIG. 7, the figures depict a first apparent location that coincides with the second apparent location, but other embodiments provide spatially separated first and second apparent locations). The faint lines that radiate from 703 are guidelines to illustrate that the rays 111 and 112 appear to radiate from location 703. The illustrative embodiments in FIGS. 8-9 further include one or both of the following: a first electromagnetic cloaking structure 121, operable to at least partially divert electromagnetic radiation at the first frequency around the second electromagnetic transducer, and a second electromagnetic cloaking structure 222, operable to at least partially divert electromagnetic radiation at the second frequency around the first electromagnetic transducer. In these figures, the depictions of the electromagnetic translation structure and the electromagnetic cloaking structures are schematic depictions only. Embodiments provide other shapes or extents of these structures, and other assemblies or configurations thereof. In some embodiments the structures are spatially separated from the other structures and/or from the electromagnetic transducers. In other embodiments the structures 121, 222, and/or 730 can be merged into, or replaced by, structures that combine operabilities of the original structures. In some embodiments, the structures 121, 222, and/or 730 can overlap (e.g. by interleaving elements that comprise the structures), and the structure 730 may itself comprise overlapping or interleaved first and second electromagnetic translation structures operable at first and second frequencies, respectively, as described in the preceding paragraph.

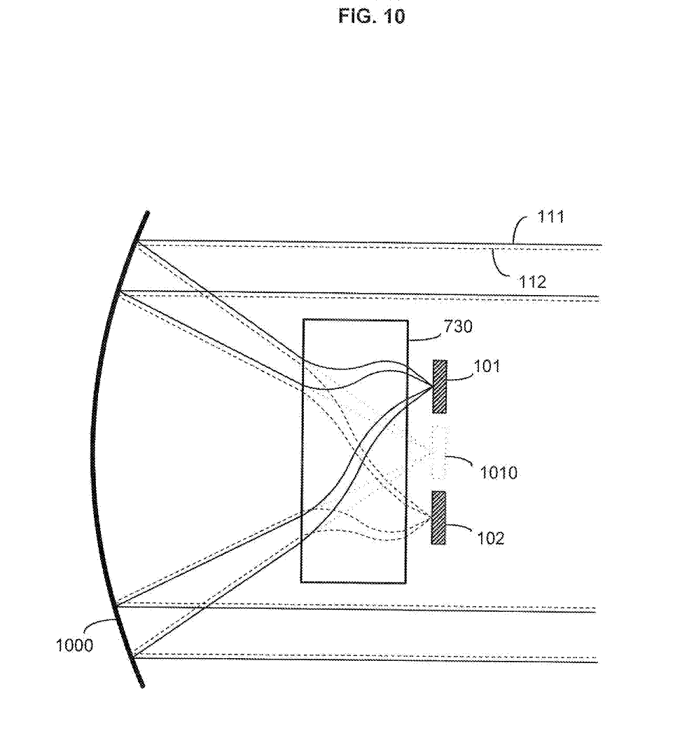

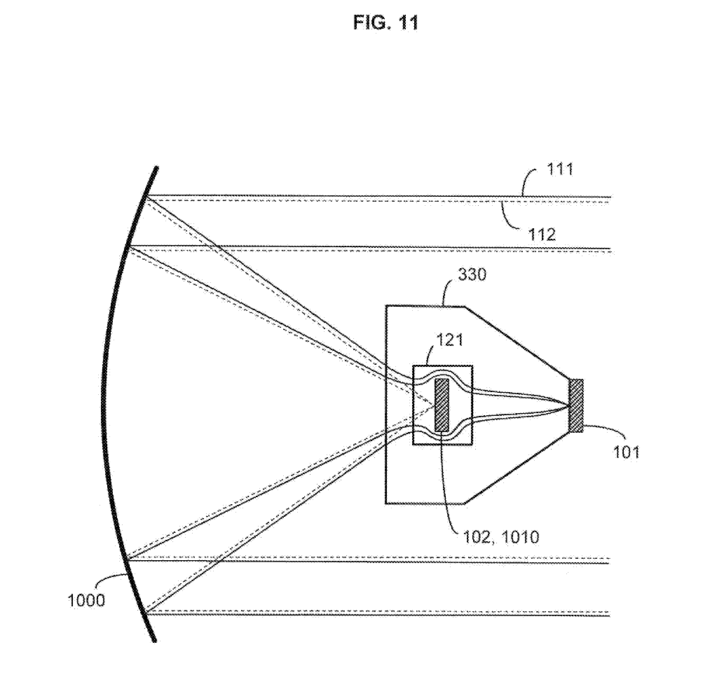

In some applications it may be desirable to operate first and second electromagnetic transducers in combination with the focusing structure defining a focal region. Focusing structures can include reflective structures (e.g. parabolic dish reflectors), refractive structures (e.g. dielectric or gradient index lenses), diffractive structures (e.g. Fresnel zone plates), and various combinations, assemblies, and hybrids thereof (such as an optical assembly or a refractive-diffractive lens). The focal region defined by a focusing structure can be, for example, a focal plane, a Petzval, sagittal, or transverse focal surface, or any other region that substantially concentrates electromagnetic radiation coupled to the focusing structure. A focusing structure can also define an f-number, which can correspond to a ratio of focal length to aperture diameter for the focusing structure, and may also characterize the divergence of electromagnetic radiation from the focal region: in general, f/x for smaller (larger) x corresponds to a faster (slower) focusing structure having a larger (smaller) divergence of electromagnetic radiation from the focal region, or equivalently, a smaller (larger) depth of focus or axial extent of the focal region. Some embodiments provide a focusing structure having an f-number f/x where x is less than or equal to 5, less than or equal to 2, or less than or equal to 1. Due to spatial or other constraints, it may be difficult or inappropriate in some configurations to position both transducers within the focal region (especially for a low f-number focusing structure having a narrower focusing region), and/or it may be problematic to prevent one transducer from obstructing (or otherwise interfering with) a field of regard of the other transducer. Embodiments for such configurations may deploy a focusing structure with first and second electromagnetic transducers in configurations that include electromagnetic cloaking structures and/or electromagnetic translation structures (e.g. as depicted in the illustrative embodiments of FIGS. 1-9). Accordingly, FIGS. 10-11 depict illustrative embodiments that include first and second electromagnetic transducers 101 and 102, respectively, and a focusing structure 1000 defining a focal region 1010, whereon rays 111 and 112 (representing electromagnetic radiation at the first and second frequencies, respectively) would nominally converge, i.e. in the absence of the electromagnetic cloaking and/or translation structures. As elsewhere in this document, the use of ray description is a heuristic convenience for purposes of visual illustration, and is not intended to connote any limitations or assumptions of geometrical optics; the depicted elements can have spatial dimensions that are variously less than, greater than, or comparable to a wavelength of interest. In FIG. 10, the illustrative embodiment further includes an electromagnetic translation structure operable at first and second frequencies (730), such as that depicted in FIG. 7. The electromagnetic translation structure operable at first and second frequencies is operable to provide a first apparent location of the first electromagnetic transducer different than an actual location of the first electromagnetic transducer for electromagnetic radiation at the first frequency, and to provide a second apparent location of the second electromagnetic transducer different than an actual location of the second electromagnetic transducer for electromagnetic radiation at the second frequency, where the first apparent location and the second apparent location correspond to the focal region 1010. Thus, electromagnetic radiation at the first frequency that would focus upon the focal region 1010 instead focuses upon the first electromagnetic transducer, and electromagnetic radiation at the second frequency that would focus upon the focal region 1010 instead focuses upon the second electromagnetic transducer. In FIG. 11, the second electromagnetic transducer 102 is positioned in the focal region 1010, and the illustrative embodiment further includes an electromagnetic cloaking structure 121 (operable to divert electromagnetic radiation at the first frequency around the second electromagnetic transducer) and an electromagnetic translation structure 330 (operable to provide an apparent location of the first electromagnetic transducer different than an actual location of the first electromagnetic transducer, where the apparent location corresponds to the focal region 1010); for comparison, FIG. 5 depicts similar cloaking and translation structures with transducers having omnidirectional fields of regard. Thus, electromagnetic radiation at the first frequency that would focus upon the focal region 1010 is instead diverted around the focal region (where the second electromagnetic transducer is positioned) to focus upon the first electromagnetic transducer, while electromagnetic radiation at the second frequency, substantially unaltered by the electromagnetic cloaking and translation structures, focuses upon the focal region 1010 (and the second electromagnetic transducer).

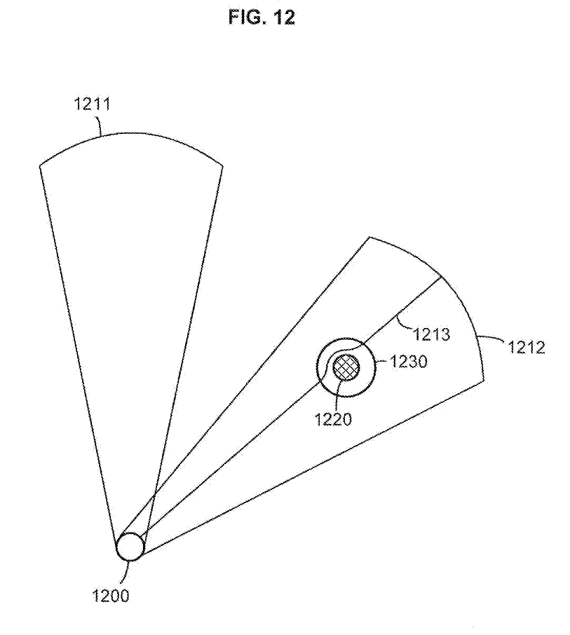

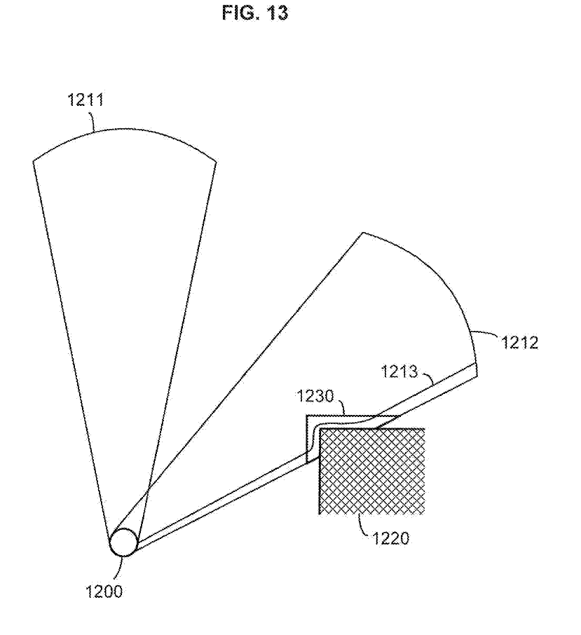

Some embodiments include a steerable electromagnetic transducer having a field of view that includes an obstruction, and an electromagnetic cloaking structure operable to at least partially divert electromagnetic radiation around the obstruction. In general, the obstruction can be any object or structure that might absorb, reflect, refract, scatter, or otherwise interact with electromagnetic radiation coupled to (e.g. transmitted from or received by) the steerable electromagnetic transducer. For example, the obstruction can be an enclosure or support element of the steerable electromagnetic transducer (e.g. a radome or antenna mast), a landscape feature (e.g. a hill or berm), another electromagnetic device (e.g. a second electromagnetic transducer), a support structure of another electromagnetic device (e.g. an antenna tower), another man-made structure (e.g. a building, wall, vessel, vehicle, or aircraft), etc. With reference now to FIGS. 12-13, illustrative embodiments are depicted that include a steerable electromagnetic transducer 1200 having first and second fields of view 1211 and 1212, respectively. An obstruction 1220 is positioned completely (in FIG. 12) or partially (in FIG. 13) within the second field of regard, and the illustrative embodiments further include an electromagnetic cloaking structure 1230 operable to at least partially divert electromagnetic radiation around the obstruction, as depicted by a representative ray 1213 of electromagnetic radiation. As elsewhere in this document, the use of ray description is a heuristic convenience for purposes of visual illustration, and is not intended to connote any limitations or assumptions of geometrical optics; the depicted elements can have spatial dimensions that are variously less than, greater than, or comparable to a wavelength of interest. The depictions in FIGS. 12-13 of the obstruction 1220 and the electromagnetic cloaking structure 1230 are schematic depictions only, and not intended to be limiting; in various embodiments the electromagnetic cloaking structure (and the obstruction that it cloaks) can take various shapes, and the electromagnetic cloaking structure need not adjoin the obstruction as it does in these illustrative embodiments.

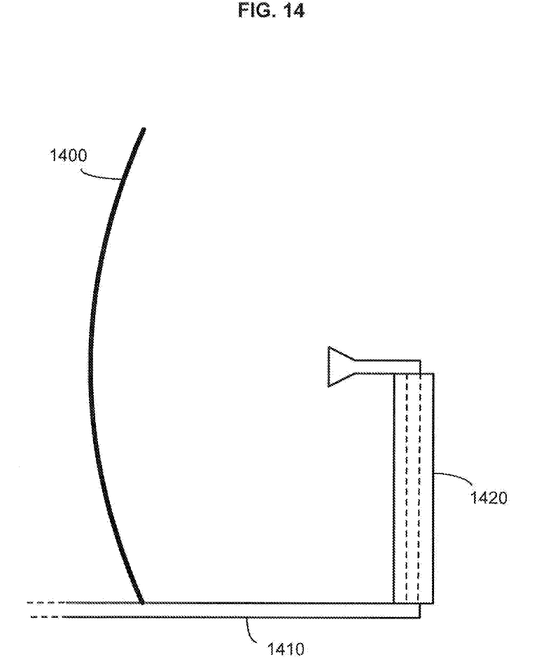

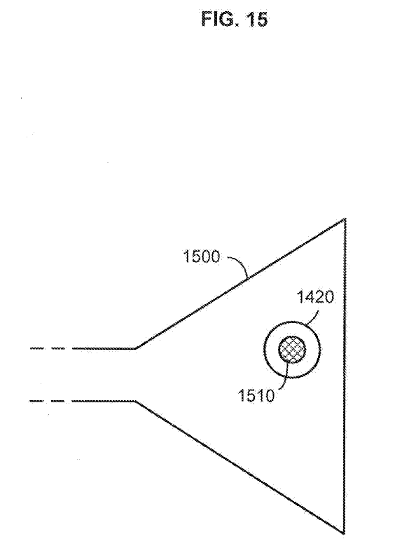

Some embodiments include an aperture electromagnetic transducer having an aperture-blocking element, and an electromagnetic cloaking structure operable to at least partially divert electromagnetic radiation around the aperture blocking element. In general, an aperture electromagnetic transducer is an electromagnetic transducer that defines a physical aperture through which transmitted or received electromagnetic radiation propagates during operation of the electromagnetic transducer (e.g. from or to an antenna feed structure or a CCD apparatus), and an aperture-blocking element is an element that might absorb, reflect, refract, scatter, or otherwise interact with electromagnetic radiation that propagates through the physical aperture. In some embodiments an aperture electromagnetic transducer is an aperture antenna. In other embodiments an aperture electromagnetic transducer is an optical device, e.g. an optical aperture telescope. Examples of aperture antennas include reflector or lens antennas, horn antennas, open-ended waveguides or transmission lines, slot antennas, and patch antennas. Examples of aperture-blocking elements include radomes attached to a reflector or horn aperture; feed support struts, subreflector support struts, or front-feed waveguides of a reflector antenna; subreflector support struts of an optical reflecting telescope; or mechanical support elements in the interior of a horn antenna. With reference now to FIGS. 14-15, illustrative embodiments are depicted that include an aperture antenna (a reflector 1400 or horn 1500) with an aperture-blocking element (a front-feed waveguide 1410 or a horn interior strut 1510) and an electromagnetic cloaking structure 1420 operable to at least partially divert electromagnetic radiation around the aperture blocking element. The electromagnetic cloaking structure is depicted as a hollow cylindrical structure (in longitudinal cross-section in FIG. 14 and axial cross-section in FIG. 15) that encloses the aperture-blocking element, but these are exemplary depictions only; in various embodiments the electromagnetic cloaking structure (and the aperture-blocking element that it cloaks) can take various shapes, and the electromagnetic cloaking structure need not adjoin the aperture-blocking element as it does in these illustrative embodiments.

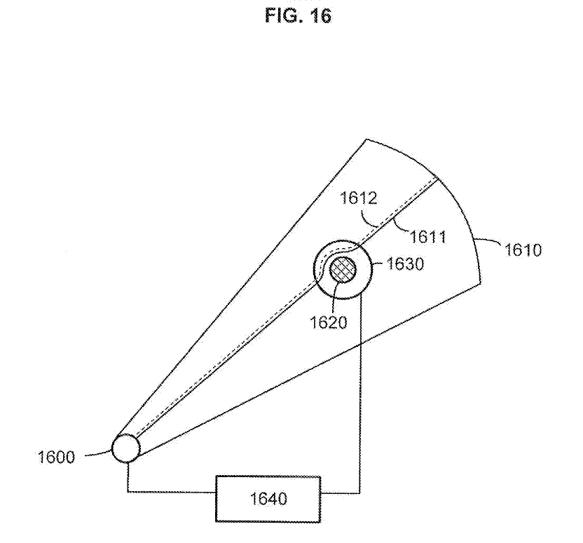

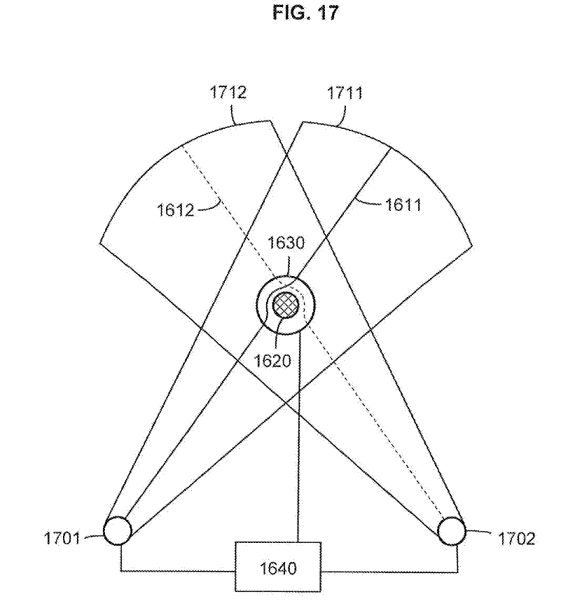

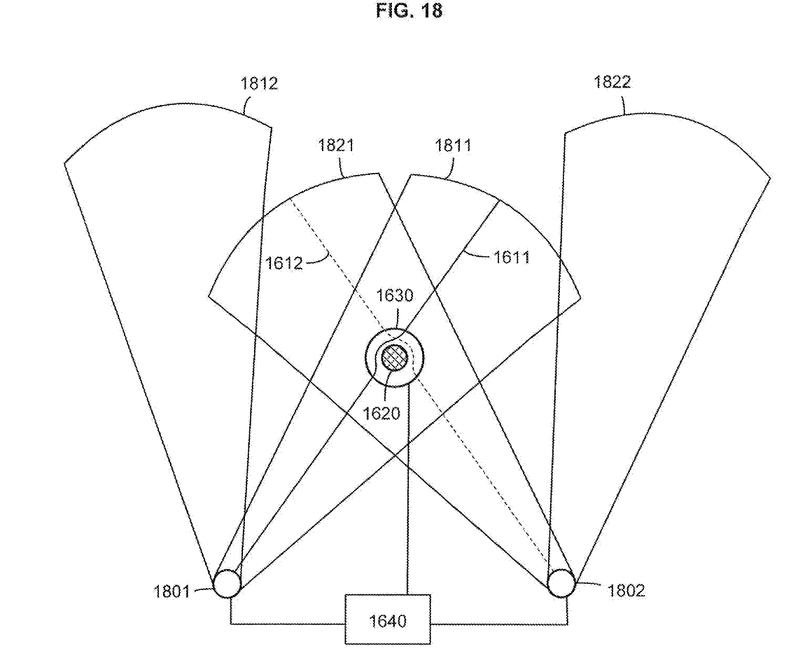

Some embodiments include an electromagnetic transducer operable at first and second frequencies, or first and second electromagnetic transducers operable at first and second frequencies, respectively; the transducer(s) have field(s) or regard (or field(s) of view) that include an obstruction, and embodiments provide an electromagnetic cloaking structure operable at first and second frequencies to at least partially divert electromagnetic radiation at the first and second frequencies around the obstruction. As before, the obstruction can generally be any object or structure that might absorb, reflect, refract, scatter, or otherwise interact with electromagnetic radiation coupled to (e.g. transmitted from or received by) the electromagnetic transducer(s), with examples provided above. With reference to FIG. 16, an illustrative embodiment is depicted that includes an electromagnetic transducer operable at first and second frequencies (1600), having a field of regard 1610. An obstruction 1620 is positioned at least partially within the field of regard, and the illustrative embodiment further includes an electromagnetic cloaking structure operable at first and second frequencies (1630) to at least partially divert electromagnetic radiation at the first and second frequencies around the obstruction, as depicted by representative rays 1611 and 1612 of electromagnetic radiation at the first and second frequencies, respectively. The illustrative embodiment optionally further includes a controller 1640 coupled to the electromagnetic transducer operable at first and second frequencies and/or the electromagnetic cloaking structure operable at first and second frequencies, as discussed below. With reference to FIG. 17, an illustrative embodiment is depicted that includes a first electromagnetic transducer 1701 operable at a first frequency and having a first field of regard 1711, and a second electromagnetic transducer 1702 operable at a second frequency and having a second field of regard 1712 at least partially overlapping the first field of regard. An obstruction 1620 is positioned at least partially within the first field of regard and at least partially within the second field of regard, and the illustrative embodiment further includes an electromagnetic cloaking structure operable at first and second frequencies (1630) to at least partially divert electromagnetic radiation at the first and second frequencies around the obstruction, as depicted by representative rays 1611 and 1612 of electromagnetic radiation at the first and second frequencies, respectively. The illustrative embodiment optionally further includes a controller 1640 coupled to the first electromagnetic transducer and/or the second electromagnetic transducer and/or the electromagnetic cloaking structure operable at first and second frequencies, as discussed below. With reference to FIG. 18, an illustrative embodiment is depicted that includes a first steerable electromagnetic transducer 1801 operable at a first frequency and having first and second fields of view 1811 and 1812, respectively, and a second electromagnetic transducer 1802 operable at a second frequency and having first and second fields of view 1821 and 1822, respectively, with the field of view 1811 at least partially overlapping the field of view 1821. An obstruction 1620 is positioned at least partially within the field of view 1811 and at least partially within the field of view 1821, and the illustrative embodiment further includes an electromagnetic cloaking structure operable at first and second frequencies (1630) to at least partially divert electromagnetic radiation at the first and second frequencies around the obstruction, as depicted by representative rays 1611 and 1612 of electromagnetic radiation at the first and second frequencies, respectively. The illustrative embodiment optionally further includes a controller 1640 coupled to the first steerable electromagnetic transducer and/or the second steerable electromagnetic transducer and/or the electromagnetic cloaking structure operable at first and second frequencies, as discussed below.

In some embodiments an electromagnetic cloaking structure operable at first and second frequencies, such as that depicted in FIGS. 16-18, includes a transformation medium having an adjustable response to electromagnetic radiation. For example, the transformation medium may have a response to electromagnetic radiation that is adjustable (e.g. in response to an external input or control signal) between a first response and a second response, the first response at least partially diverting electromagnetic radiation at a first frequency around an obstruction, and the second response at least partially diverting electromagnetic radiation at a second frequency around the obstruction. A transformation medium with an adjustable electromagnetic response may be implemented with variable metamaterials, e.g. as described in R. A. Hyde et al, supra. In embodiments where the electromagnetic cloaking structure operable at first and second frequencies is adjustable in response to an external input or control signal, the external input or control signal may be provided by a controller, such as that depicted as element 1640 in FIGS. 16-18. The controller can include, for example, circuitry for adjusting between a first response and a second response of the electromagnetic cloaking structure operable at first and second frequencies, to provide the first response when electromagnetic radiation at the first frequency irradiates the electromagnetic cloaking structure and the second response when electromagnetic radiation at the second frequency irradiates the electromagnetic cloaking structure.

In other embodiments an electromagnetic cloaking structure operable at first and second frequencies, such as that depicted in FIG. 16-18, includes a transformation medium having a frequency-dependent response to electromagnetic radiation, corresponding to frequency-dependent constitutive parameters. For example, the frequency-dependent response at a first frequency may at least partially divert electromagnetic radiation at a first frequency around an obstruction, and the frequency-dependent response at a second frequency may at least partially divert electromagnetic radiation at a second frequency around the obstruction. A transformation medium having a frequency-dependent response to electromagnetic radiation can be implemented with metamaterials; for example, a first set of metamaterial elements having a response at the first frequency may be interleaved with a second set of metamaterial elements having a response at the second frequency. Alternatively or equivalently, in some embodiments the electromagnetic cloaking structure operable at first and second frequencies is a combination of a first electromagnetic cloaking structure operable at the first frequency and a second electromagnetic cloaking structure operable at the second frequency; the first and second electromagnetic cloaking structures are then combined by, for example, interleaving of their respective elements, or by nesting one cloaking structure inside the other (e.g. to provide a multi-layered, multi-frequency cloaking structure).

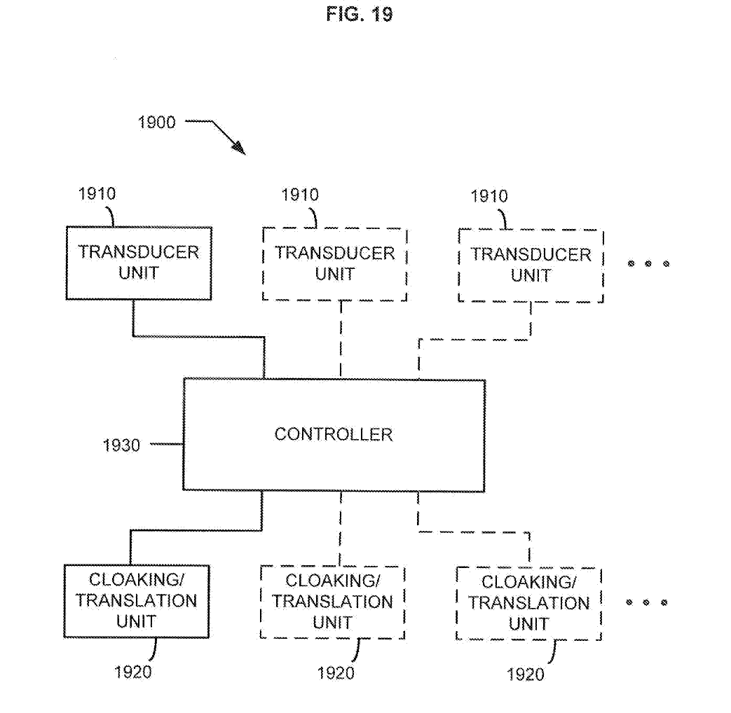

With reference now to FIG. 19, an illustrative embodiment is depicted as a system block diagram. The system 1900 includes one or more electromagnetic transducer units 1910 and one or more electromagnetic cloaking/translation units 1920 coupled to a controller unit 1930. A transducer unit 1910 may include a electromagnetic transducer (such as an antenna) and associated circuitry such as transmitter circuitry, receiver circuitry, and/or steering control circuitry. An electromagnetic cloaking/translation unit 1920 may include an electromagnetic cloaking structure and/or an electromagnetic translation structure (such as those described in preceding embodiments) or a combination thereof. The controller unit 1930 may monitor, coordinate, synchronize, or otherwise control the operations of the one or more electromagnetic transducer units 1910, and accordingly adjust the operations of the electromagnetic cloaking/translation units 1920. For example, where an electromagnetic cloaking/translation unit 1920 includes an electromagnetic cloaking structure disposed to remove electromagnetic effects of an obstruction, as in FIGS. 16-18, the controller unit 1930 may alternate duty cycles or observe sweep patterns of first and second electromagnetic transducer units 1910 (operable at first and second frequencies, respectively) and correspondingly adjust the operation of the electromagnetic cloaking/translation unit 1920 (i.e. to operate at first and second frequencies in synchrony with the first and second electromagnetic transducer units). As another example, where an electromagnetic cloaking/translation unit 1920 accommodates a deployment of first and second electromagnetic transducer units 1910 with a focusing structure, e.g. as depicted in FIGS. 10-11, the controller unit 1930 may alternate duty cycles of first and second electromagnetic transducer units 1910 (operable at first and second frequencies, respectively) and correspondingly adjust the operation of the electromagnetic cloaking/translation unit 1920 (i.e. to operate at first and second frequencies in synchrony with the first and second electromagnetic transducer units).

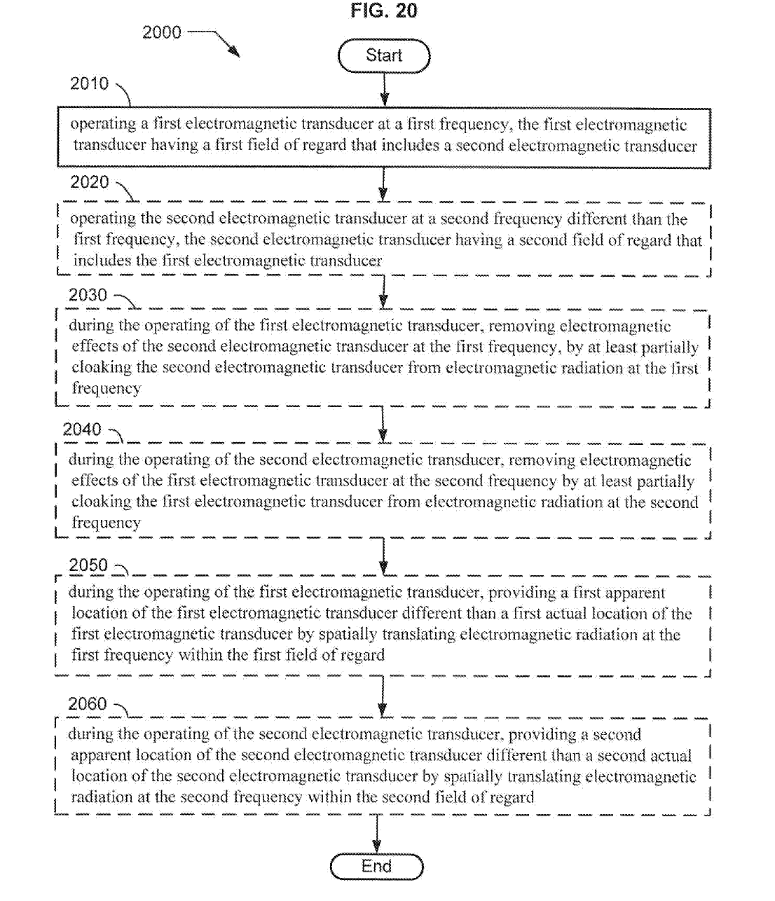

An illustrative embodiment is depicted as a process flow diagram in FIG. 20. Flow 2000 includes operation 2010—operating a first electromagnetic transducer at a first frequency, the first electromagnetic transducer having a first field of regard that includes a second electromagnetic transducer. For example, a first antenna may transmit radiation at a radio frequency, a CCD apparatus may detect radiation at an optical frequency corresponding to a visible wavelength, etc. Flow 2000 optionally further includes operation 2020—operating the second electromagnetic transducer at a second frequency different than the first frequency, the second electromagnetic transducer having a second field of regard that includes the first electromagnetic transducer. For example, a second antenna may detect radiation at a radio frequency, a semiconductor laser may emit radiation at an optical frequency corresponding to an infrared wavelength, etc. Flow 2000 optionally further includes operation 2030—during the operating of the first electromagnetic transducer, removing electromagnetic effects of the second electromagnetic transducer at the first frequency, by at least partially cloaking the second electromagnetic transducer from electromagnetic radiation at the first frequency. For example, a first electromagnetic cloaking structure (such as that depicted as element 121 in FIGS. 1-2, 5-6, 8-9, and 11) may divert electromagnetic radiation at the first frequency around the second electromagnetic transducer. Flow 2000 optionally further includes operation 2040—during the operating of the second electromagnetic transducer, removing electromagnetic effects of the first electromagnetic transducer at the second frequency by at least partially cloaking the first electromagnetic transducer from electromagnetic radiation at the second frequency. For example, a second electromagnetic cloaking structure (such as that depicted as element 222 in FIGS. 2, 4, 6, and 9) may divert electromagnetic radiation at the second frequency around the second electromagnetic transducer. Flow 2000 optionally further includes operation 2050—during the operating of the first electromagnetic transducer, providing a first apparent location of the first electromagnetic transducer different than a first actual location of the first electromagnetic transducer by spatially translating electromagnetic radiation at the first frequency within the first field of regard. For example, an electromagnetic translation structure (such as that depicted as element 330 in FIGS. 3-6 and 11 or as element 730 in FIGS. 7-10) may spatially translate electromagnetic radiation at the first frequency by refracting electromagnetic radiation at the first frequency through the electromagnetic translation structure, which refracting may be substantially nonreflective. Flow 2000 optionally further includes operation 2060—during the operating of the second electromagnetic transducer, providing a second apparent location of the second electromagnetic transducer different than a second actual location of the second electromagnetic transducer by spatially translating electromagnetic radiation at the second frequency within the second field of regard. For example, an electromagnetic translation structure (such as that depicted as element 730 in FIGS. 7-10) may spatially translate electromagnetic radiation at the second frequency by refracting electromagnetic radiation at the second frequency through the electromagnetic translation structure, which refracting may be substantially nonreflective.

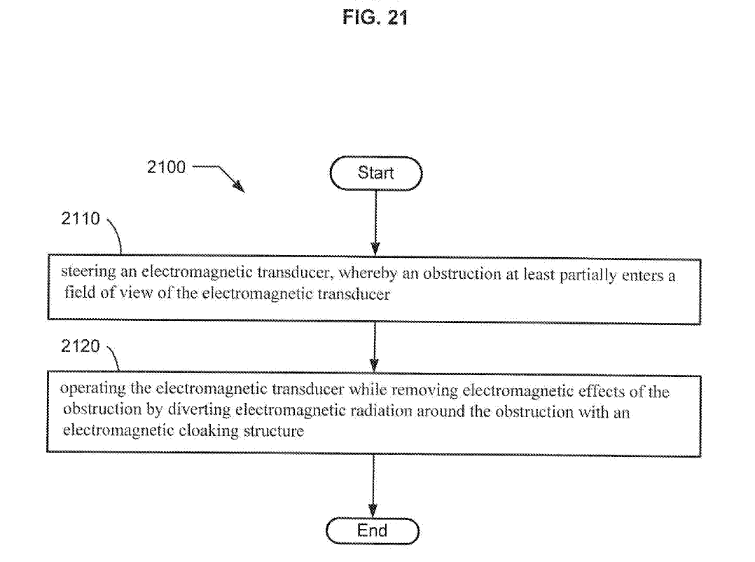

Another illustrative embodiment is depicted as a process flow diagram in FIG. 21. Flow 2100 includes operation 2110—steering an electromagnetic transducer, whereby an obstruction at least partially enters a field of view of the electromagnetic transducer. For example, an antenna mounted on a gimbal may be mechanically steered whereby an obstruction enters its field of view, or an adjustably phased array may be electrically steered whereby an obstruction enters its field of view. Flow 2100 further includes operation 2120—operating the electromagnetic transducer while removing electromagnetic effects of the obstruction by diverting electromagnetic radiation around the obstruction with an electromagnetic cloaking structure. For example, electromagnetic radiation emitted or absorbed by the electromagnetic transducer may be diverted through a metamaterial structure having an effective permittivity and permeability corresponding to a transformation medium.

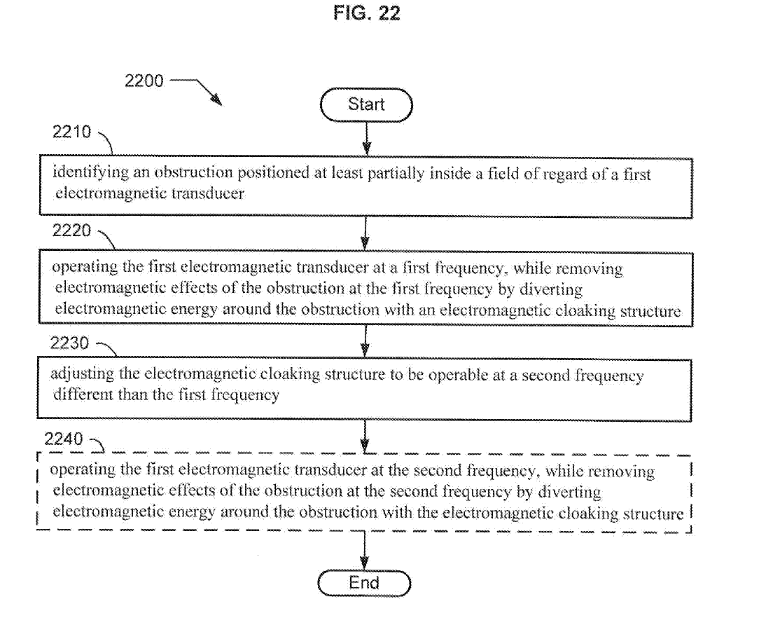

Another illustrative embodiment is depicted as a process flow diagram in FIG. 22. Flow 2200 includes operation 2210—identifying an obstruction positioned at least partially inside a field of regard of a first electromagnetic transducer. For example, the obstruction may be a radome, a support structure, a landscape feature, etc. Flow 2200 further includes operation 2220—operating the first electromagnetic transducer at a first frequency, while removing electromagnetic effects of the obstruction at the first frequency by diverting electromagnetic energy around the obstruction with an electromagnetic cloaking structure. For example, electromagnetic energy emitted or absorbed by the first electromagnetic transducer at the first frequency may be diverted through a metamaterial structure having an effective permittivity and permeability corresponding to a transformation medium. Flow 2200 further includes operation 2230—adjusting the electromagnetic cloaking structure to be operable at a second frequency different than the first frequency. For example, a control signal (e.g. from a controller) may adjust a response of the electromagnetic cloaking structure (e.g. by adjusting resonant frequencies of a metamaterial). Flow 2200 optionally further includes operation 2240—operating the first electromagnetic transducer at the second frequency, while removing electromagnetic effects of the obstruction at the second frequency by diverting electromagnetic energy around the obstruction with the electromagnetic cloaking structure. For example, electromagnetic energy emitted or absorbed by the first electromagnetic transducer at the second frequency may be diverted through a metamaterial structure having an effective permittivity and permeability corresponding to a transformation medium.

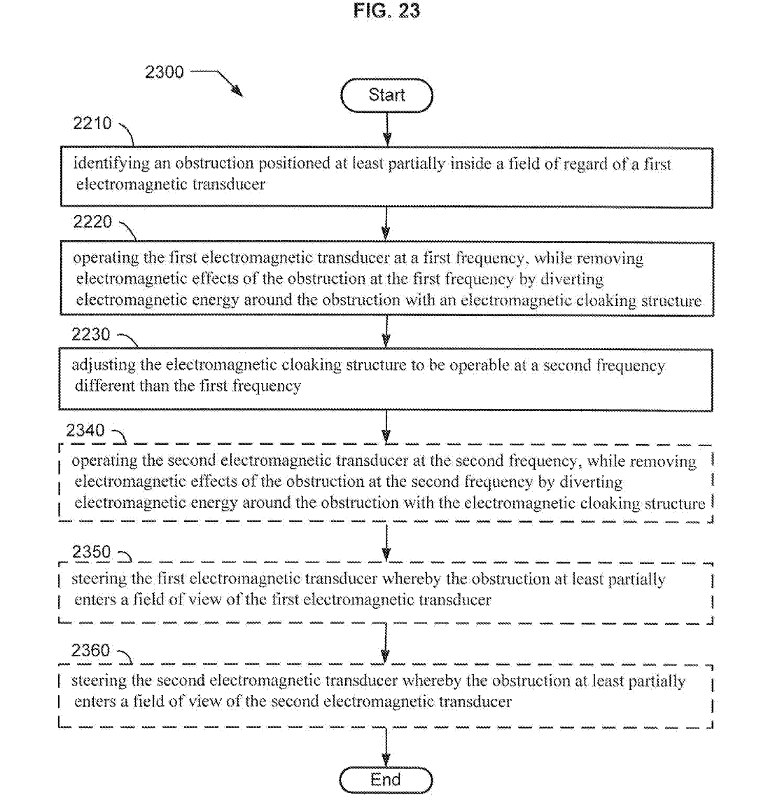

Another illustrative embodiment is depicted as a process flow diagram in FIG. 23. Flow 2300 includes operations 2210, 2220, and 2230, as in FIG. 22. Flow 2300 optionally further includes operation 2340—operating the second electromagnetic transducer at the second frequency, while removing electromagnetic effects of the obstruction at the second frequency by diverting electromagnetic energy around the obstruction with the electromagnetic cloaking structure. For example, electromagnetic energy emitted or absorbed by the second electromagnetic transducer at the second frequency may be diverted through a metamaterial structure having an effective permittivity and permeability corresponding to a transformation medium. Flow 2300 optionally further includes operation 2350—steering the first electromagnetic transducer whereby the obstruction at least partially enters a field of view of the first electromagnetic transducer—and/or operation 2360—steering the second electromagnetic transducer whereby the obstruction at least partially enters a field of view of the second electromagnetic transducer. For example, an antenna mounted on a gimbal may be mechanically steered whereby an obstruction enters its field of view, or an adjustably phased array may be electrically steered whereby an obstruction enters its field of view.

The reference D. Smith et al, “Indefinite materials,” U.S. patent application Ser. No. 10/525,191, patented as U.S. Pat. No. 7,522,124 and above incorporated by reference, includes the following text:

In order to further describe exemplary metamaterials that comprise the layers of a multi-layer structure of the invention, the simple example of an idealized medium known as the Drude medium may be considered which in certain limits describes such systems as conductors and dilute plasmas. The averaging process leads to a permittivity that, as a function frequency, has the form

∈(f)/∈₀=1−fₚ²/f(f+iy) EQTN. 1

where f is the electromagnetic excitation frequency, fₚ is the plasma frequency and γ is a damping factor. Note that below the plasma frequency, the permittivity is negative. In general, the plasma frequency may be thought of as a limit on wave propagation through a medium: waves propagate when the frequency is greater than the plasma frequency, and waves do not propagate (e.g., are reflected) when the frequency is less than the plasma frequency, where the permittivity is negative. Simple conducting systems (such as plasmas) have the dispersive dielectric response as indicated by EQTN 1.

The plasma frequency is the natural frequency of charge density oscillations (“plasmons”), and may be expressed as:

ωₚ=[n_{eff}e²/∈₀m_{eff}]^{1/2}

and

fₚ=ωₚ/2π

where n_{eff} is the charge earner density and m_{eff} is an effective carrier mass. For the carrier densities associated with typical conductors, the plasma frequency fₚ usually occurs in the optical or ultraviolet bands.

Pendry et al. in “Extremely Low Frequency Plasmons in Metallic Mesostructures,” Physical Review Letters, 76(25):4773-6, 1996, teach a thin wire media in which the wire diameters are significantly smaller than the skin depth of the metal can be engineered with a plasma frequency in the microwave regime, below the point at which diffraction due to the finite wire spacing occurs. By restricting the currents to flow in thin wires, the effective charge density is reduced, thereby lowering the plasma frequency. Also, the inductance associated with the wires acts as an effective mass that is larger than that of the electrons, further reducing the plasma frequency. By incorporating these effects, the Pendry reference provides the following prediction for the plasma frequency of a thin wire medium:

$${f}_{p}^{2} = \frac{1}{2 π} ( \frac{{c}_{0}^{2} / {d}^{2}}{ln ( \frac{d}{r} ) - \frac{1}{2} ( 1 + ln π )} )$$

where c₀ is the speed of light in a vacuum, d is the thin wire lattice spacing, and r is the wire diameter. The length of the wires is assumed to be infinite and, in practice, preferably the wire length should be much larger than the wire spacing, which in turn should be much larger than the radius.

By way of example, the Pendry reference suggests a wire radius of approximately one micron for a lattice spacing of 1 cm—resulting in a ratio, d/r, on the order of or greater than 10⁵. Note that the charge mass and density that generally occurs in the expression for the fₚ are replaced by the parameters (e.g., d and r) of the wire medium. Note also that the interpretation of the origin of the “plasma” frequency for a composite structure is not essential to this invention, only that the frequency-dependent permittivity have the form as above, with the plasma (or cutoff) frequency occurring in the microwave range or other desired ranges. The restrictive dimensions taught by Pendry et al. are not generally necessary, and others have shown wire lattices comprising continuous or noncontinuous wires that have a permittivity with the form of EQTN 1.

The wire medium just described, and its variants, is characterized by the effective permittivity given in EQTN 1, with a permeability roughly constant and positive. In the following, such a medium is referred to as an artificial electric medium. Artificial magnetic media can also be constructed for which the permeability can be negative, with the permittivity roughly constant and positive. Structures in which local currents are generated that flow so as to produce solenoidal currents in response to applied electromagnetic fields, can produce the same response as would occur in magnetic materials. Generally, any element that includes a non-continuous conducting path nearly enclosing a finite area and that introduces capacitance into the circuit by some means, will have solenoidal currents induced when a time-varying magnetic field is applied parallel to the axis of the circuit.

We term such an element a solenoidal resonator, as such an element will possess at least one resonance at a frequency ωₘ₀ determined by the introduced capacitance and the inductance associated with the current path. Solenoidal currents are responsible for the responding magnetic fields, and thus solenoidal resonators are equivalent to magnetic scatterers. A simple example of a solenoidal resonator is ring of wire, broken at some point so that the two ends come close but do not touch, and in which capacitance has been increased by extending the ends to resemble a parallel plate capacitor. A composite medium composed of solenoidal resonators, spaced closely so that the resonators couple magnetically, exhibits an effective permeability. Such an composite medium was described in the text by I. S. Schelkunoff and H. T. Friis, Antennas: Theory and Practice, Ed. S. Sokolnikoff (John Wiley & Sons, New York, 1952), in which the generic form of the permeability (in the absence of resistive losses) was derived as

$$μ ( ω ) = 1 - \frac{F {ω}^{2}}{{ω}^{2} - {ω}_{m 0}^{2}} \qquad EQTN . 2$$

where F is a positive constant less than one, and ωₘ₀ is a resonant frequency. Provided that the resistive losses are low enough, EQTN 2 indicates that a region of negative permeability should be obtainable, extending from ωₘ₀ to ωₘ₀/\sqrt{1−F}.

In 1999, Pendry et al. revisited the concept of magnetic composite structures, and presented several methods by which capacitance could be conveniently

introduced into solenoidal resonators to produce the magnetic response (Pendry et al., Magnetism from Conductors and Enhanced Nonlinear Phenomena, IEEE Transactions on Microwave Theory and Techniques, Vol. 47, No. 11, pp. 2075-84, Nov. 11, 1999). Pendry et al. suggested two specific elements that would lead to composite magnetic materials. The first was a two-dimensionally periodic array of “Swiss rolls,” or conducting sheets, infinite along one axis, and wound into rolls with insulation between each layer. The second was an array of double split rings, in which two concentric planar split rings formed the resonant elements. Pendry et al. proposed that the latter medium could be formed into two- and three-dimensionally isotropic structures, by increasing the number and orientation of double split rings within a unit cell.

Pendry et al. used an analytical effective medium theory to derive the form of the permeability for their artificial magnetic media. This theory indicated that the permeability should follow the form of EQTN 2, which predicts very large positive values of the permeability at frequencies near but below the resonant frequency, and very large negative values of the permeability at frequencies near but just above the resonant frequency, ωₘ₀.

The reference J. B. Pendry et al, “Magnetism from conductors and enhanced nonlinear phenomena,” IEEE Trans. Micro. Theo. Tech. 47, 2075 (1999), above incorporated by reference, includes the following text:
C “Swiss Roll” Capacitor
. . . In this instance, we find for the effective permeability

$$\begin{matrix}{μ}_{eff} = 1 - \frac{F}{1 + \frac{2 σ i}{ω r {μ}_{0} ( N - 1 )} - \frac{1}{2 {π}^{2} {r}^{3} {{μ}_{0} ( N - 1 )}^{2} {ω}^{2} C}} \\ = 1 - \frac{\frac{π {r}^{2}}{{a}^{2}}}{1 + \frac{2 σ i}{ω r {μ}_{0} ( N - 1 )} - \frac{{dc}_{0}^{2}}{2 {π}^{2} {r}^{3} ( N - 1 ) {ω}^{2}}}\end{matrix} \qquad ( 29 )$$

where F is as before the fraction of the structure not internal to a cylinder, and the capacitance per unit area between the first and the last of the coils is

$$C = \frac{{ɛ}_{0}}{d ( N - 1 )} = \frac{1}{{μ}_{0} {dc}_{0}^{2} ( N - 1 )} . \\ … \qquad ( 30 )$$

IV. An Isotropic Magnetic Material

. . . We propose an adaptation of the “split ring” structure, in which the cylinder is replaced by a series of flat disks each of which retains the “split ring” configuration, but in slightly modified form . . . .

The effective magnetic permeability we calculate, on the assumption that the rings are sufficiently close together and that the magnetic lines of force are due to currents in the stacked rings, are essentially the same as those in a continuous cylinder. This can only be true if the radius of the rings is of the same order as the unit cell side. We arrive at

$$\begin{matrix}{μ}_{eff} = 1 - \frac{\frac{π {r}^{2}}{{a}^{2}}}{1 + \frac{2 {𝓁σ}_{1}}{ω r {μ}_{0}} i - \frac{3 𝓁}{{π}^{2} {μ}_{0} {ω}^{2} {C}_{1} {r}^{3}}} \\ = 1 - \frac{\frac{π {r}^{2}}{{a}^{2}}}{1 + \frac{2 {𝓁σ}_{1}}{ω r {μ}_{0}} i - \frac{3 𝓁 {c}_{0}^{2}}{{πω}^{2} ln \frac{2 c}{d} {r}^{3}}}\end{matrix} \qquad ( 43 )$$

where σ₁ is the resistance of unit length of the sheets measured around the circumference.

While the preceding embodiments have generally recited structures and transducers operable at first and second frequencies (or first and second frequency bands), it will be apparent to one of skill in the art that similar embodiments can recite structures and transducers operable at a plurality of frequencies (or frequency bands). For example, embodiments can provide a plurality of electromagnetic transducers (operable at a respective plurality of frequencies or frequency bands) with a corresponding plurality of electromagnetic cloaking structures (operable to at least partially divert electromagnetic radiation at the i th frequency around the j th electromagnetic transducer for j≠i), and/or with a corresponding plurality of electromagnetic translation structures (operable to provide apparent location(s) of the electromagnetic transducers different than actual locations of the electromagnetic transducers).

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1-37. (canceled)

38. An apparatus, comprising:
a first electromagnetic transducer operable at a first frequency and having a first field of regard;
a second electromagnetic transducer operable at a second frequency different than the first frequency, the second electromagnetic transducer positioned at least partially inside the first field of regard; and
a transformation medium having electromagnetic properties selected to at least partially cloak the second electromagnetic transducer from electromagnetic radiation at the first frequency.

39. The apparatus of claim 38, wherein the second electromagnetic transducer has a second field of regard that includes the first electromagnetic transducer, and wherein the electromagnetic properties of the transformation medium are further selected to at least partially cloak the first electromagnetic transducer from electromagnetic radiation at the second frequency.

40. The apparatus of claim 39, wherein the electromagnetic properties of the transformation medium are further selected to provide a first apparent location of the first electromagnetic transducer different than a first actual location of the first electromagnetic transducer for electromagnetic radiation at the first frequency.

41. The apparatus of claim 40, wherein the electromagnetic properties of the transformation medium are further selected to provide a second apparent location of the second electromagnetic transducer different than a second actual location of the second electromagnetic transducer for electromagnetic radiation at the second frequency.

42. The apparatus of claim 38, wherein the electromagnetic properties of the transformation medium are further selected to provide a first apparent location of the first electromagnetic transducer different than a first actual location of the first electromagnetic transducer for electromagnetic radiation at the first frequency.

43. The apparatus of claim 42, wherein the electromagnetic properties of the transformation medium are further selected to provide a second apparent location of the second electromagnetic transducer different than a second actual location of the second electromagnetic transducer for electromagnetic radiation at the second frequency.

44. The apparatus of claim 38, wherein the electromagnetic properties of the transformation optical medium are further selected to provide an apparent location of the second electromagnetic transducer different than an actual location of the second electromagnetic transducer for electromagnetic radiation at the second frequency.

45. An apparatus, comprising:
a first electromagnetic transducer operable at a first frequency;
a second electromagnetic transducer operable at a second frequency different than the first frequency; and
a transformation optical medium having electromagnetic properties selected to provide a first apparent location of the first electromagnetic transducer different than a first actual location of the first electromagnetic transducer for electromagnetic radiation at the first frequency, and further selected to provide a second apparent location of the second electromagnetic transducer different than a second actual location of the second electromagnetic transducer for electromagnetic radiation at the second frequency.

46. An apparatus, comprising:
a steerable electromagnetic transducer having a field of view that is adjustable to include an obstruction; and
an electromagnetic cloaking structure operable to at least partially divert electromagnetic radiation around the obstruction.

47-74. (canceled)
